(19) United States
(12) Patent Application Publication
(10) Pub. No.: US 2012/0167179 A1
(43) Pub. Date: Jun. 28, 2012

(54) FLEXIBLE MULTIMEDIA PRIORITY SERVICES

(75) Inventors: Paul J. Evans, Montreal (CA); Shabnam Sultana, Westmount (CA); John Barna, Montreal (CA)

(73) Assignee: TELEFONAKTIEBOLAGET L M ERICSSON (PUBL), Stockholm (SE)

(21) Appl. No.: 12/977,642

(22) Filed: Dec. 23, 2010

(51) Int. Cl. H04W 12/06

(52) U.S. Cl. 726/4

(57) ABSTRACT

Presented is a system and methods for allowing a user, through their end user device, to invoke and access on-demand and always-on time interval based multimedia priority services (MPS). The time interval can be specified by the user directly for the user's session or provided by a managing authority for a plurality of user sessions. The time interval can be specified as a period from user invocation forward or as a start time/date pair to an end time/date pair.

### TECHNICAL FIELD

The present invention relates generally to policy, provisioning and charging for multimedia priority services (MPS) and more specifically to providing enhanced usage of MPS services.

### BACKGROUND

The availability of public communication networks, such as the 3rd Generation Partnership Project (3GPP) based network, has become so widespread and reliable that federal, state and local governments are adopting the networks as a communication medium for implementation of communications systems for government authorized users and emergency first responders. In a similar fashion, private commercial enterprises requiring the widespread availability of communication services have turned to the 3GPP based networks as an alternative to privately owned communication systems.

Historically, both the public and the private sector relied on proprietary private networks for meeting their priority communication service needs, a decision requiring a large financial commitment to maintain and operate the communication network. One of the major factors behind the decision to use a private communication network was the requirement for priority service when times of emergency or natural disaster occurred. In an effort to provide the availability of a private network on the public 3GPP communication network, the 3GPP specification was updated to add Multimedia Priority Services (MPS). The changes to the specification provide priority treatment to specified users in the public radio access and core networks including IMS (Internet Protocol Multimedia Subsystem) during periods of congestion.

While the 3GPP specification changes address the theoretical needs of priority access to communication services, the implementation of the specification could be seen as challenging for the user of a mobile device and service providers planning to be innovative when using the MPS. Implementations currently approved provide only two types of MPS users, an explicit invocation (i.e. On-Demand) user and a non-explicit invocation (i.e. Always-On) user whose profile is configured for priority access without any need for explicit invocation. Further, the commercial market for MPS demands a higher granularity of user control over the access to MPS and the duration of MPS services for any given user and the associated mobile device.

The explicit invocation or On-Demand MPS user must explicitly invoke priority service for each access by successfully completing a predefined procedure. For example, the user can be required to enter a pre-defined access code in order to make a priority access and the priority service lasts only for the duration of the call/session. If the user makes another priority access the pre-defined access code must be entered again to grant priority access to the network. The non-explicit invocation user relies on a user profile to inform the operator network that the mobile user requires priority service. Although this may be more convenient for the user because the need for entering access codes is eliminated, the user is always using MPS and the user is paying for this higher level of service even when not required.

Consequently, market pressure is building for an MPS system which would overcome at least some of the drawbacks described above.

### SUMMARY

Systems and methods according to the present invention allow, among other things, an operator network to provide MPS to government and commercial users where the users have greater flexibility in configuring the duration of the invoked service. In one example, the user could configure the service to last for a user specified period of time from an explicit invocation. In another example, the user could specify, for one or more devices associated with the user, a begin time and date and an end time and date for access to MPS. Systems and methods according to the present invention address the market needs described above by associating on-demand service requests with a time period which allows subsequent priority treatment for the service without explicit invocation. For example, a service request made by a user and approved by the appropriate authority or by the authorized service provider could be associated with its own charging case for the duration of the specified period. The service could be available to public safety officials and/or commercial users based on configuration by the operator network/service provider.

In one exemplary embodiment, a method for providing a user on-demand time-based authorization multimedia priority services (MPS) is presented. The exemplary method embodiment includes the following steps. In the first exemplary method embodiment step, a request is received from a user invoking an MPS. In the next exemplary method embodiment step, a determination is made as to whether the user is authorized to use the MPS. Continuing to the next exemplary method embodiment step, an authorized user is granted permission to the MPS for an associated time interval without requiring further authorization for additional invocations of the MPS during the associated time interval.

In another exemplary embodiment, a system for providing multimedia priority services based on a configured time interval is presented. The exemplary system embodiment includes the following components. The first exemplary system embodiment component is an analysis component for determining if a user is invoking an MPS. The next exemplary system embodiment component is an authorization component for determining if the user is authorized to use a MPS for an associated time interval without requiring further authorization for additional invocations of the MPS. Continuing, the next exemplary system embodiment component is a storage component for storing data associated with determining if the user is invoking a MPS and if the user is authorized to use a MPS for an associated time interval without requiring further authorization for additional invocations of the MPS.

Further, in another exemplary embodiment, for users without any MPS subscription, the user's subscription can be invoked with MPS for a specific period of time via an application function (AF) under the operator network/service provider's control. For example, in another exemplary embodiment, a user has access to a web site where the user can select priority access for one or more days. Continuing with the exemplary embodiment, the AF interacts with the user database for the user (e.g. in 3GPP that would be a home subscriber server (HSS) and a subscription profile repository (SPR)), giving the user appropriate priority access.

In another exemplary embodiment, users with Always-On priority service subscription can access a web site and decline further priority access. Continuing with the exemplary embodiment, the user can downgrade priority for a time when the user does not desire access priority (e.g. going on vacation). In the two previous exemplary embodiments, users as well as operator networks benefit from being able to apply flexible charging associated with upgrading or downgrading priority.

### BRIEF DESCRIPTION OF THE DRAWINGS

The accompanying drawings illustrate exemplary embodiments, wherein:

FIG. 1 depicts a system for a user to invoke a multimedia priority service (MPS) for an associated time interval without requiring further authorization for subsequent invocations of the MPS during the associated time interval;

FIG. 2 depicts a system, facilitated by a charging component, for a user to invoke a MPS for an associated time interval without requiring further authorization for subsequent invocations of the MPS during the associated time interval;

FIG. 3 depicts a system, facilitated by a notification component, for a user to invoke a MPS for an associated time interval without requiring further authorization for subsequent invocations of the MPS during the associated time interval;

FIG. 4 is a flowchart depicting requests and responses between different nodes in a communication network providing MPS for an associated time interval without requiring further authorization for subsequent invocations of the MPS during the associated time interval;

FIG. 5 is a flowchart depicting a network operator method for providing MPS for an associated time interval without requiring further authorization for subsequent invocations of the MPS during the associated time interval; and

FIG. 6 depicts an exemplary computing device for implementing a system for a user to invoke a multimedia priority service (MPS) for an associated time interval without requiring further authorization for subsequent invocations of the MPS during the associated time interval.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

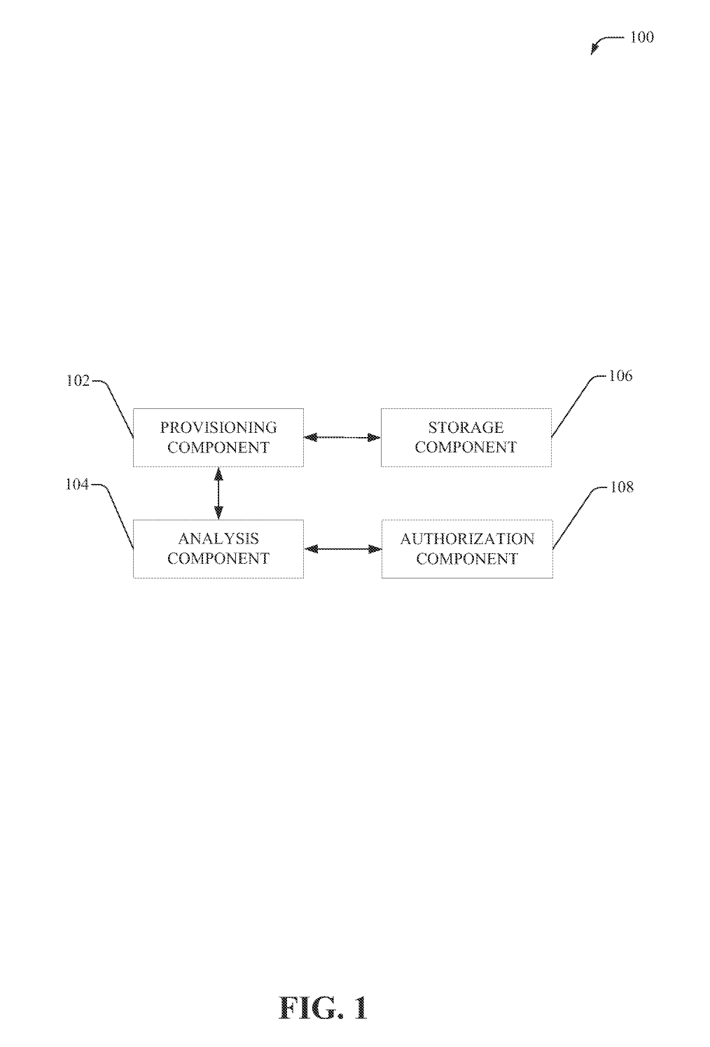

Looking first to FIG. 1, a diagram of an exemplary embodiment of an enhanced Multimedia Priority Services (MPS) system 100 for providing user access to the MPS during an associated time interval without requiring further authorization for subsequent invocations is illustrated. The exemplary embodiment of the enhanced MPS system 100 includes but is not limited to an exemplary provisioning component 102, an exemplary analysis component 104, an exemplary storage component 106 and an exemplary authorization component 108. It should be noted in this exemplary embodiment that MPS are services that, in part, can elevate the priority of an authorized user to a level that increases the probability that the user will have responsive and reliable access to the selected service.

In one aspect of the exemplary embodiment, the provisioning component 102 can provide the ability to configure a user subscription on a communication network. In another aspect of the exemplary embodiment, the provisioning component 102 can provide a configuration value indicating that the user is allowed access to the time-interval enhancement of the MPS. In a further aspect of the exemplary embodiment, the provisioning component 102 can provide a time interval for subsequent activation or a begin time/date pair matched with and end time/date pair to create a time interval of the MPS authorization.

In one example of the exemplary embodiment, the provisioning component 102 can accept a user entered time interval of twenty-four hours of access to the MPS and configure the user profile such that the user can invoke the MPS as many times as desired during this twenty-four hour interval and the user is not required to enter authorization information for each of these subsequent invocations. In another example of the exemplary embodiment, the provisioning component 102 can accept a managing authority supplied time interval, the time interval can be provided as a start date and time and an end date and time. In this exemplary embodiment, the user is not required to explicitly request the MPS and can be notified that the user is using the MPS for the specified time interval. It should be noted in the exemplary embodiment that the provisioning component 102 can be part of a home subscriber server (HSS).

In another aspect of the exemplary embodiment, the analysis component 104 can provide the ability to determine if the user is invoking the MPS. In one aspect of the exemplary embodiment, the analysis component 104 can detect that the user has entered a time interval when requesting the MPS. In another exemplary embodiment, an emergency responder arrives at the scene of an accident and estimates that it will take four hours to complete the processing of the location. Continuing with the exemplary embodiment, the emergency responder can initiate a MPS and provide a time interval of four hours. In another aspect of the exemplary embodiment, the analysis component 104 can detect that the user is requesting MPS and has not supplied a time interval with the request. Continuing with the exemplary embodiment, the analysis component 104 can use a pre-determined default time interval stored in the HSS as the time interval to provide MPS.

Next, in the exemplary embodiment, the analysis component 104 can process the request for the MPS and detect the parameter specifying a four-hour time interval or a time interval pre-provisioned in the network. Continuing with the exemplary embodiment, the analysis component 104 can communicatively request authorization from the authorization component 108 allowing the user to access the service and if access is granted, the analysis component 104 can communicatively contact the storage component 106 for persistent storage of the time interval. It should be noted in the exemplary embodiment that the analysis component 104 can be part of the policy control and charging rules function (PCRF).

Continuing with another aspect of the exemplary embodiment, the storage component 106 can provide the capability to store data indicating whether the invoking user is authorized to use MPS with an associated time interval. For example, in the exemplary embodiment the storage component 106 can manage a storage location for a flag indicating a true or false state with true indicating the user is allowed to access the MPS with an associated time interval and false indicating the user is not allowed to access the MPS with an associated time interval. It should be noted in the exemplary embodiment that the storage component 106 can use other data types and values to represent the status of the user with respect to accessing the time interval enhancement of the MPS.

In another aspect of the exemplary embodiment, the storage component 106 can provide the capability to store data indicating the time interval associated with the MPS. For example, in the exemplary embodiment the storage component 106 can manage a storage location for a specified number of hours to allow access to the MPS without requiring further authorization of the user for subsequent invocations of the MPS. In a further exemplary embodiment, the storage component 106 can manage a storage location capable of storing a beginning time/date pair and an ending time/date pair creating a time interval based on the period between the two time/date pairs. For example, in the exemplary embodiment any authorized user invoking a MPS between the starting date/time pair and the ending date/time pair will not be required to enter authorization information and may not be aware they are using MPS. It should be noted in the exemplary embodiment that the storage component 106 can be part of a home subscriber server (HSS) and can store its associated data in a subscription profile repository (SPR) or it can be maintained in an AF which has access to HSS/SPR.

In a further aspect of the exemplary embodiment, an authorization component 108 can provide the capability to determine if a user is authorized to use the time interval enhancement of the MPS. In one exemplary embodiment, the authorization component 108 can obtain information from a data location stored by the storage component 106 and based on the value of the data, allow or refuse access by the user to the time interval enhanced MPS. It should be noted in the exemplary embodiment that the authorization component 108 can be part of the policy control and charging rules function and can determine if the user can access MPS based on currently active policy and charging control (PCC) rules or by querying the subscription profile registry (SPR).

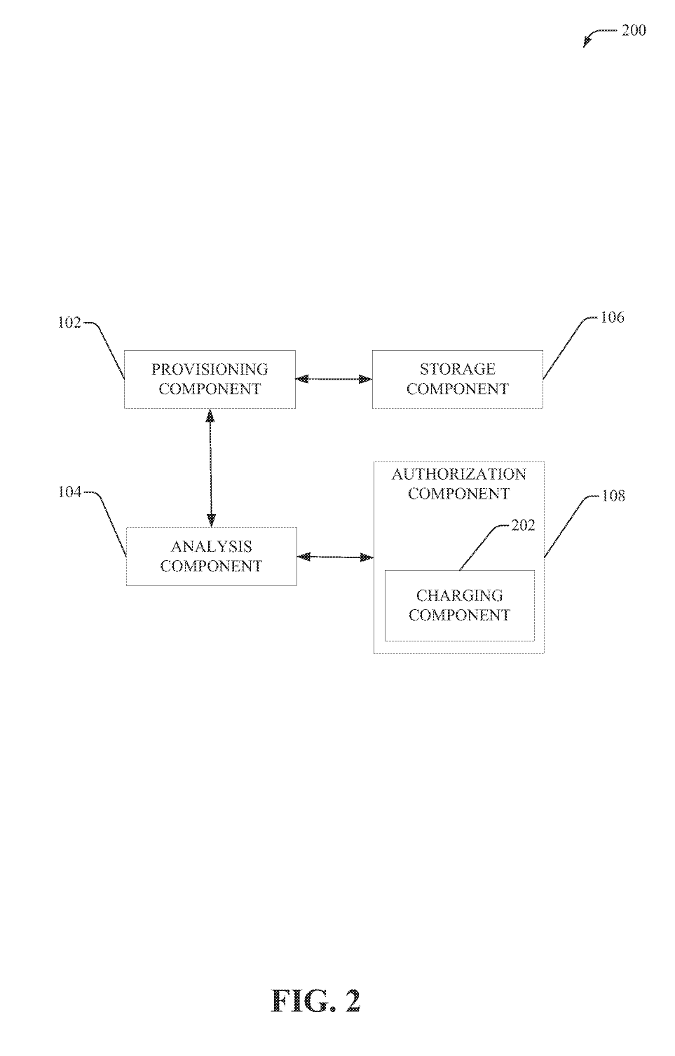

Looking now to FIG. 2, another exemplary embodiment 200 is depicted. A portion of the exemplary embodiment 200 depicts an authorization component 108 including a charging component 202. In one aspect of the exemplary embodiment 200 the charging component 202 can provide the capability to charge the user account the time interval based MPS amount for each access to the MPS, during the specified time interval, even though the user is not required to provide further authorization information for subsequent MPS invocations during the specified time interval. In another aspect of the exemplary embodiment 200, the charging component can charge the user account for time interval based MPS access based on a managing authority configuring a time interval for one or more users. If a user accesses a service during the configured time interval then the user automatically receives MPS and is charged accordingly for time interval based MPS access. It should be noted in the exemplary embodiment 200 that the charging component 202 can be part of an online charging system (OCS).

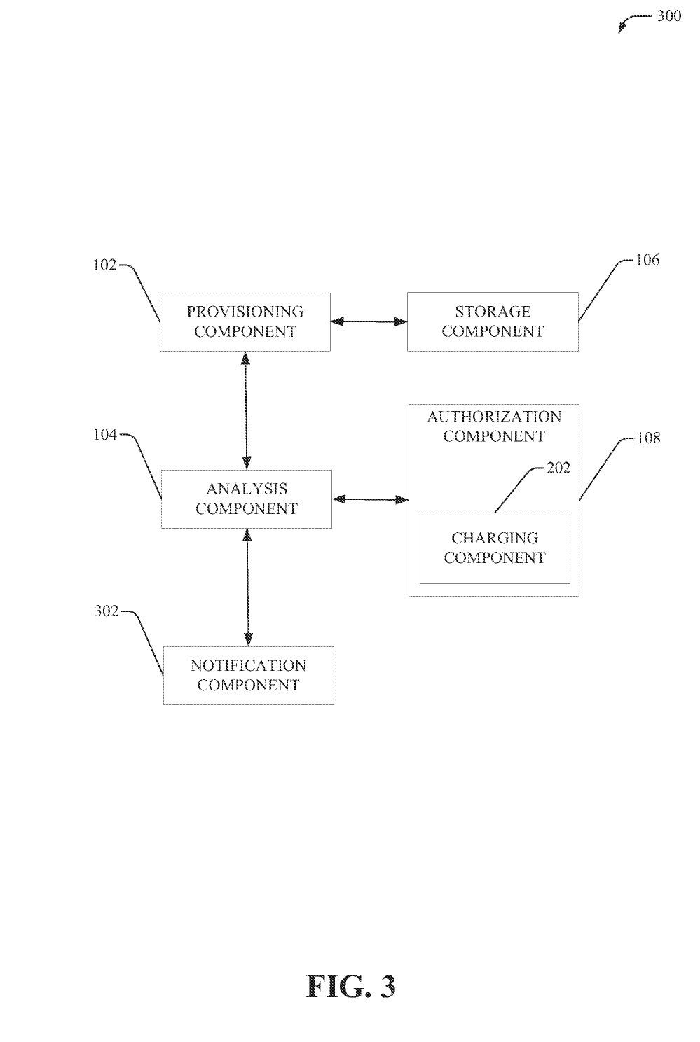

Turning now to FIG. 3, another exemplary embodiment 300 is depicted. A portion of the exemplary embodiment 300 depicts a notification component 302. In one aspect of the exemplary embodiment 300, the notification component 302 can provide the capability to notify the user that the user is authorized to access time interval based MPS and/or that the user is currently being charged for time interval based MPS access. In another aspect of the exemplary embodiment, based on the notification that the user is authorized and being charged for time interval enhanced MPS, the user can advise the notification component 302 to cancel the user's access to time interval enhanced MPS, therefore providing the option for the user to opt out of a managing authority configured time interval enhanced MPS. In a further aspect of the exemplary embodiment, the user can cancel a user invoked time interval enhanced MPS by advising the notification component 302 of the user's desire to end the time interval enhanced MPS. It should be noted in the exemplary embodiment that the notification component 108 can be part of the application function (AF) or part of the subscription profile repository (SPR).

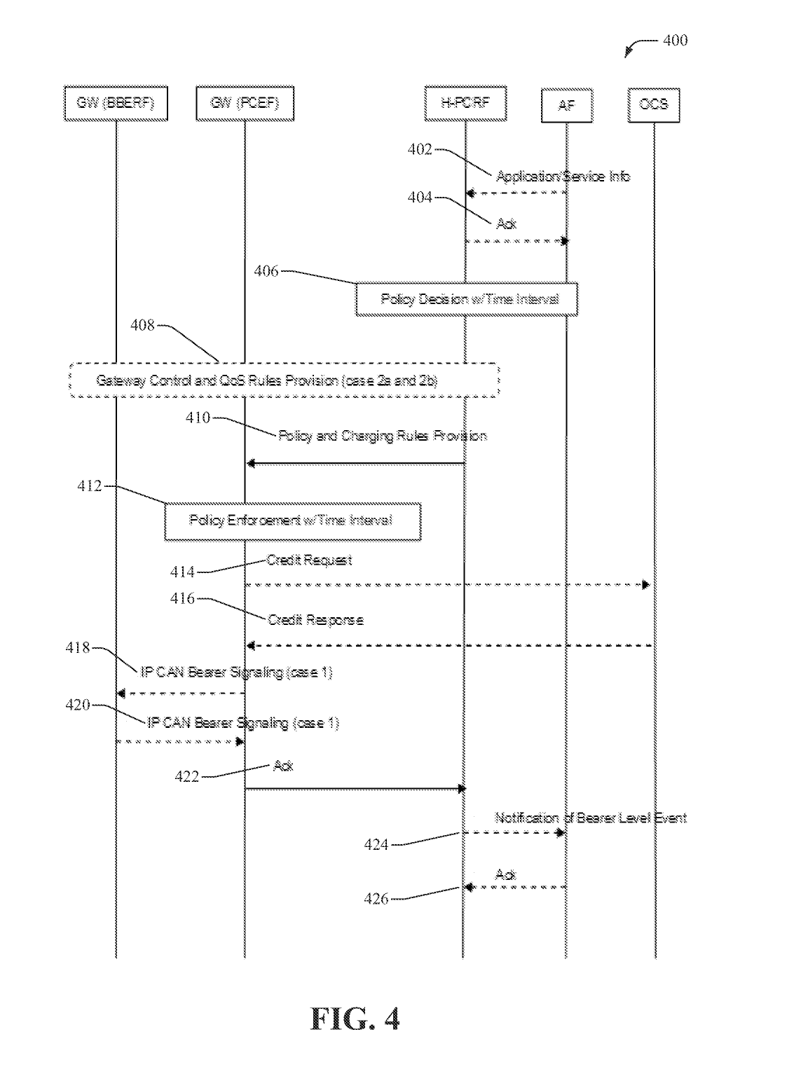

Turning now to FIG. 4, illustrated is an exemplary embodiment 400. The exemplary embodiment 400 depicts the signaling flow for an internet protocol—connectivity access network (IP-CAN) session modification initiated by the policy control and charging rules function (PCRF) (see 3GPP TS 23.203 v10.1.0, incorporated herein by reference, section 7.4.2) with modification at steps 406 and 412 to reflect invocation and authorization of a time interval access to MPS. It should be noted in the exemplary embodiment that an application function (AF) can be involved. Further, in the exemplary embodiment an example of the scenario is initiated and authorization of a session-based service for which an IP-CAN session is modified. It should be noted in the exemplary embodiment that IP-CAN session handling and handling of policy and charging control (PCC) rules that are not subject to AF-interaction is also applicable. It should further be noted in this non-limiting exemplary embodiment that the roaming case has been omitted for clarity.

First, at exemplary embodiment step 402, optionally, the AF can provide/revoke service information to/from the PCRF due to the AF session signaling and the AF can subscribe, at this point, to notification of bearer level events related to the service information. It should be noted in this step of the exemplary embodiment, that for the PCRF to generate the applicable events, the PCRF instructs the policy and charging enforcement function (PCEF) to report events related to the corresponding PCC rules. It should further be noted in this step of the exemplary embodiment that the events related to the PCC rules are not shown in this exemplary embodiment flow diagram, for clarity. Continuing now to step 404 of the exemplary embodiment, the PCRF stores the service information, if available, and responds with the acknowledgment to the AF. It should be noted in this step of the exemplary embodiment that without AF interaction, a trigger event in the PCRF can cause the PCRF to determine that the PCC rules require updating at the PCEF e.g. change to configured policy. It should further be noted in this step of the exemplary embodiment that this procedure can also be triggered by the gateway control (GC) and quality of service (QoS) rules request procedure as described in section 7.7.3 of the 3GPP TS previously incorporated by reference.

Continuing now with step 406 of the exemplary embodiment, the PCRF makes the authorization and policy decision, including recognizing an invocation of a time interval enhancement of a MPS and authorizing the use of the time interval enhancement of the MPS. Further, at step 408 of the exemplary embodiment, if there is no GC and QoS rules reply pending and there is a need to provision QoS rules, the PCRF initiates a GC and QoS rules provision procedure as defined in section 7.7.4 of the 3GPP TS (applicable for cases 2a and 2b, as defined in section 7.1 of the 3GPP TS). Continuing with the exemplary embodiment, if there are multiple bearer binding and event functions (BBERF) associated with the IP-CAN session, then exemplary embodiment step 408 is performed with the BBERFs that support UE/NW bearer establishment mode. It should be noted in the exemplary embodiment that if there is a GW control and QoS rules reply pending, e.g. this procedure was invoked from the GW control and QoS rules request procedure as defined in section 7.7.3 of the 3GPP TS, the PCRF shall use that opportunity for provisioning the applicable QoS rules. Further noting in the exemplary embodiment, if there are multiple BBERFs associated with the IP-CAN session, and the procedure was invoked by a GW control and QoS rules request procedure from the primary BBERF, the PCRF may receive a GW control and QoS rules request from the non-primary BBERFs.

Looking now to step 410 of the exemplary embodiment, the PCRF sends the policy and charging rules provision (PCC rules, event trigger, event report) to the PCEF. Continuing with step 412 of the exemplary embodiment, the PCEF enforces the decision. In another aspect of step 412 of the exemplary embodiment, if the data value representing the user's authorization to access the time interval based MPS represents access allowed, then the user can continue using the time interval enhanced MPS without providing further authorization credentials. Turning now to step 414 of the exemplary embodiment, if online charging is applicable, the PCEF may request credit for new charging keys and/or shall return the remaining credit for charging keys no longer active to the online charging system (OCS). Alternatively, as opposed to credit-based payment, prepaid access can be implemented for MPS services as described herein.

Continuing with step 416 of the exemplary embodiment, if the OCS was involved, the OCS provides the credit information to the PCEF and/or acknowledges the credit report. Further, at step 418 of the exemplary embodiment the GW(PCEF) may send an IP-CAN bearer establishment, modification or termination request (applicable for case 1, as defined in section 7.1 of the 3GPP TS). In another aspect of the exemplary embodiment, an IP-CAN bearer modification is sent by the GW(PCEF) if the QoS of the IP-CAN bearer exceeds the authorized QoS provided by the PCRF in step 406 above. In a further aspect of the exemplary embodiment, an IP-CAN bearer termination request is sent by the GW(PCEF) if all PCC rules for an IP-CAN bearer have been removed.

Looking now to exemplary embodiment step 420, the GW(PCEF) receives the response for the IP-CAN bearer modification or termination request (applicable for case 1, as defined in section 7.1 of the 3GPP TS). Continuing with exemplary embodiment step 422, the PCEF sends an acknowledge policy and charging rules provisioning (accept or reject the PCC rules operations) to the PCRF. Next at step 424 of the exemplary embodiment, if the AF requested, the PCRF notifies the AF related bearer level events (e.g. transmission resources are established/released/lost). Continuing with step 426 of the exemplary embodiment, the AF acknowledges the notification from the PCRF.

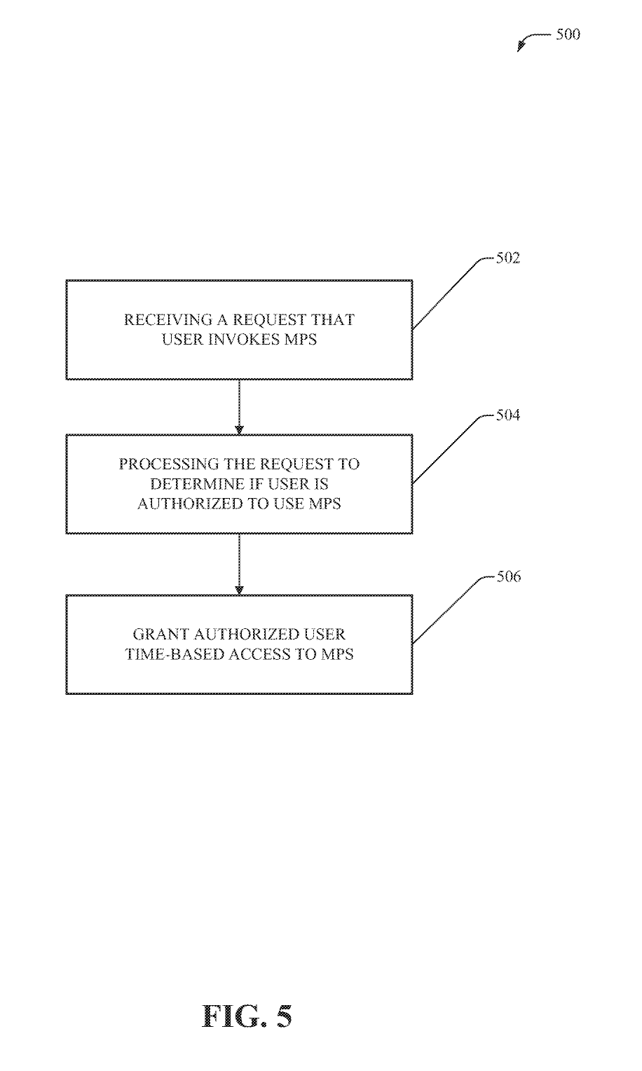

Looking now to FIG. 5, an exemplary method embodiment 500 for providing a user on-demand time interval based MPS is depicted. Starting at step 502, the exemplary method embodiment 500 can receive a user's invocation request for an MPS. In one aspect of the exemplary method embodiment 500 the invocation request is a direct request from the user, including a time interval parameter. In another aspect of exemplary method embodiment 500, the invocation request can come directly from the user and a managing authority provides the time interval. Next at step 504, another aspect of the exemplary method embodiment 500 can process the invocation request and can determine if the user is authorized to invoke time interval based MPS. The exemplary method embodiment 500 can evaluate the data stored by storage component 106 and allow or deny access to the time interval based MPS based on the data value.

Continuing to step 506 of the exemplary method embodiment 500, based on the previously evaluated data value, another aspect of the exemplary method embodiment 500 can grant the user access to the time interval based MPS. Continuing with the exemplary method embodiment 500, after access is granted the user is not required to provide security credentials for further invocations of the MPS during the specified time interval.

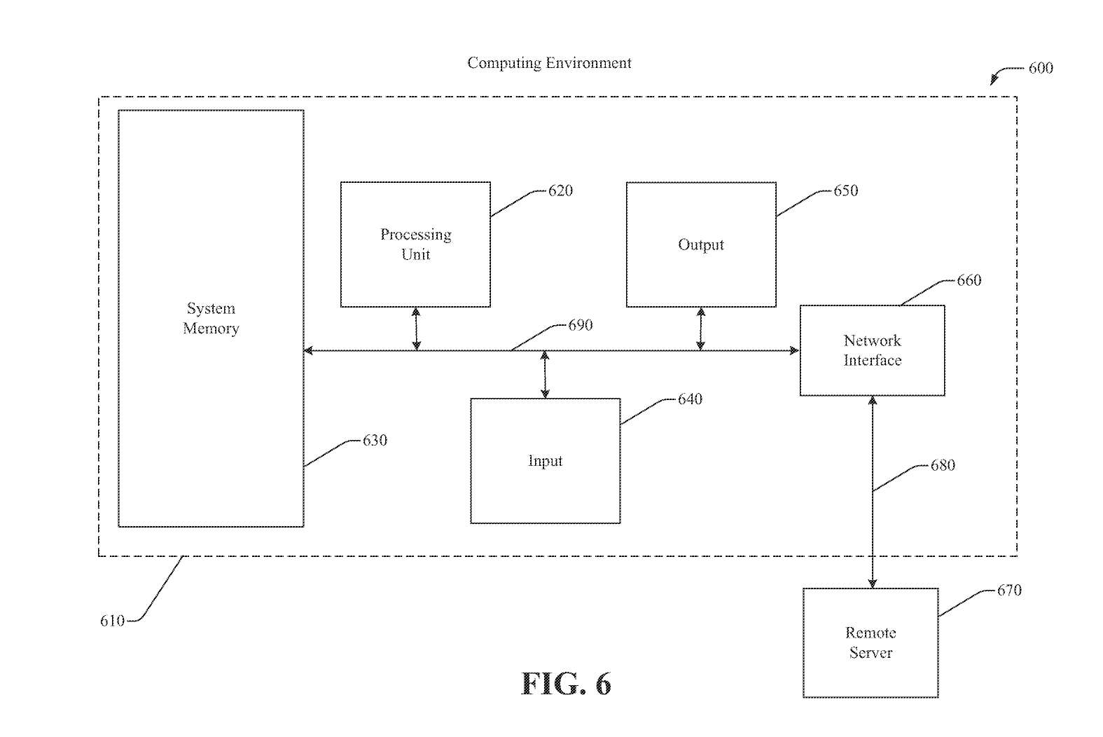

FIG. 6 illustrates an example of a suitable computing system environment 600 in which the claimed subject matter can be implemented, although as made clear above, the computing system environment 600 is only one example of a suitable computing environment for an exemplary embodiment and is not intended to suggest any limitation as to the scope of use or functionality of the claimed subject matter. Further, the computing environment 600 is not intended to suggest any dependency or requirement relating to the claimed subject matter and any one or combination of components illustrated in the example computing environment 600.

Looking now to FIG. 6, an example of a device for implementing the previously described innovation includes a general purpose computing device in the form of a computer 610. Components of computer 610 can include, but are not limited to, a processing unit 620, a system memory 630, and a system bus 690 that couples various system components including the system memory to the processing unit 620. The system bus 690 can be any of several types of bus structures including a memory bus or memory controller, a peripheral bus, and a local bus using any of a variety of bus architectures.

Computer 610 can include a variety of computer readable media. Computer readable media can be any available media that can be accessed by computer 610. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 610. Communication media can embody computer readable instructions, data structures, program modules or other data in a modulated data signal such as a carrier wave or other transport mechanism and can include any suitable information delivery media.

The system memory 630 can include computer storage media in the form of volatile and/or nonvolatile memory such as read only memory (ROM) and/or random access memory (RAM). A basic input/output system (BIOS), containing the basic routines that help to transfer information between elements within computer 610, such as during start-up, can be stored in memory 630. Memory 630 can also contain data and/or program modules that are immediately accessible to and/or presently being operated on by processing unit 620. By way of non-limiting example, memory 630 can also include an operating system, application programs, other program modules, and program data.

The computer 610 can also include other removable/non-removable and volatile/nonvolatile computer storage media. For example, computer 610 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus 690 through a non-removable memory interface such as an interface, and a magnetic disk drive or optical disk drive can be connected to the system bus 690 by a removable memory interface, such as an interface.

A user can enter commands and information into the computer 610 through input devices such as a keyboard or a pointing device such as a mouse, trackball, touch pad, and/or other pointing device. Other input devices can include a microphone, joystick, game pad, satellite dish, scanner, or similar devices. These and/or other input devices can be connected to the processing unit 620 through user input 640 and associated interface(s) that are coupled to the system bus 690, but can be connected by other interface and bus structures, such as a parallel port, game port or a universal serial bus (USB).

A graphics subsystem can also be connected to the system bus 690. In addition, a monitor or other type of display device can be connected to the system bus 690 through an interface, such as output interface 650, which can in turn communicate with video memory. In addition to a monitor, computers can also include other peripheral output devices, such as speakers and/or printing devices, which can also be connected through output interface 650.

The computer 610 can operate in a networked or distributed environment using logical connections to one or more other remote computers, such as remote server 670, which can in turn have media capabilities different from device 610. The remote server 670 can be a personal computer, a server, a router, a network PC, a peer device or other common network node, and/or any other remote media consumption or transmission device, and can include any or all of the elements described above relative to the computer 610. The logical connections depicted in FIG. 6 include a network 680, such as a local area network (LAN) or a wide area network (WAN), but can also include other networks/buses.

When used in a LAN networking environment, the computer 610 is connected to the LAN 680 through a network interface or adapter. When used in a WAN networking environment, the computer 610 can include a communications component, such as a modem, or other means for establishing communications over a WAN, such as the Internet. A communications component, such as a modem, which can be internal or external, can be connected to the system bus 690 through the user input interface at input 640 and/or other appropriate mechanism.

In a networked environment, program modules depicted relative to the computer 610, or portions thereof, can be stored in a remote memory storage device. It should be noted that the network connections shown and described are exemplary and other means of establishing a communications link between the computers can be used.

Additionally, it should be noted that as used in this application, terms such as “component,” “display,” “interface,” and other similar terms are intended to refer to a computing device, either hardware, a combination of hardware and software, software, or software in execution as applied to a computing device implementing a virtual keyboard. For example, a component may be, but is not limited to being, a process running on a processor, a processor, an object, an executable, a thread of execution, a program and a computing device. As an example, both an application running on a computing device and the computing device can be components. One or more components can reside within a process and/or thread of execution and a component can be localized on one computing device and/or distributed between two or more computing devices, and/or communicatively connected modules. Further, it should be noted that as used in this application, terms such as “system user,” “user,” and similar terms are intended to refer to the person operating the computing device referenced above.

Further, the term to “infer” or “inference” refer generally to the process of reasoning about or inferring states of the system, environment, user, and/or intent from a set of observations captured from events and/or data. Captured events and data can include user data, device data, environment data, behavior data, application data, implicit and explicit data, etc. Inference can be employed to identify a specific context or action, or can generate a probability distribution over states, for example. The inference can be probabilistic in that the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The above-described exemplary embodiments are intended to be illustrative in all respects, rather than restrictive, of the present innovation. Thus the present innovation is capable of many variations in detailed implementation that can be derived from the description contained herein by a person skilled in the art. All such variations and modifications are considered to be within the scope and spirit of the present innovation as defined by the following claims. No element, act, or instruction used in the description of the present application should be construed as critical or essential to the invention unless explicitly described as such. Also, as used herein, the article “a” is intended to include one or more items.

1. A method, stored in a memory and executing on a processor, for providing a user, on a communication network, an enhanced multimedia priority service (MPS), the method comprising:
receiving a request from said user to invoke said MPS;
processing said request to determine if said user is authorized to use said MPS; and
granting an authorized user access to said MPS in response to said request for an associated time interval without requiring further authorization of said authorized user for additional invocations of said MPS during said associated time interval.

2. The method of claim 1, wherein said MPS is a set of services and features on said communication network for providing the ability to deliver telephone calls or complete sessions of a high priority nature between said communication network and other communication networks.

3. The method of claim 1, further comprising provisioning said user on said communication network.

4. The method of claim 3, wherein said provisioning of said user further comprises adding said user to a subscription profile repository (SPR) or a home subscriber server (HSS).

5. The method of claim 3, wherein said provisioning of said user further comprises creating a data storage location for storing a data value indicating whether said user is allowed to access said MPS.

6. The method of claim 3, wherein said provisioning of said user further comprises creating a data storage location for storing said associated time interval said user is allowed to access said MPS.

7. The method of claim 1, wherein said associated time interval begins at said user's next invocation of said MPS.

8. The method of claim 1, wherein said associated time interval begins at a first specified date and time and ends at a second specified date and time.

9. The method of claim 1, wherein said associated time interval is provided as input from said user during said MPS invocation.

10. The method of claim 1, wherein said associated time interval is provided by a managing authority responsible for authorizing said user's access to MPS.

11. The method of claim 1, wherein said associated time interval is a pre-determined default time interval stored in a home subscriber server (HSS).

12. The method of claim 1, wherein said associated time interval is provided as input from said user at a web page associated with said communication network.

13. The method of claim 1, wherein determining when said user invokes said MPS further comprises detecting an associated time interval provided with a request for said MPS.

14. The method of claim 1, wherein determining if said user is authorized to use said MPS further comprises a determination by a policy control and charging rules function (PCRF) based on currently active policy and charging control (PCC) rules.

15. The method of claim 1, wherein determining if said user is authorized to use said MPS further comprises a determination by a policy control and charging rules function (PCRF) based on querying a subscription profile repository (SPR).

16. The method of claim 10, further comprising notifying said user when said managing authority has enabled said user's access to said MPS.

17. The method of claim 16, wherein notifying said user further comprises sending said user a short message service (SMS) communication indicating said MPS access.

18. The method of claim 16, wherein notifying said user further comprises sending said user a internet protocol multimedia service (IMS) communication indicating said MPS access.

19. The method of claim 1, further comprising cancelling said associated time interval for said MPS access by said user.

20. A system for providing multimedia priority services (MPS) to a user of a communication network, said system comprising:
a processor for executing computer instructions and a memory for storing said computer instructions wherein said computer instructions further comprise:
an analysis component for determining if said user is invoking said MPS;
an authorization component for determining if said user is authorized to use said MPS based on an associated time interval and without requiring further authorization of said user for additional invocations of said MPS; and
a storage component for storing data associated with determining if said user is invoking said MPS and if said user is authorized to use said MPS.

21. The system of claim 20, further comprising a provisioning component for adding said user to a database on said communication network.

22. The system of claim 20, wherein said authorization component further comprises a charging component for determining a portion of said user's authorization.

23. The system of claim 20, wherein said provisioning component is a component of a home subscriber server (HSS).

24. The system of claim 20, wherein said authorization component is a component of a policy control and charging rules function (PCRF).

25. The system of claim 20, wherein said storage component is a component of a subscription profile repository (SPR).

26. The system of claim 20, further comprising a notification component for notifying said user's mobile device that a managing authority has authorized said user for accessing said EMPS for a pre-determined period of time.
